(19) United States
(12) Patent Application Publication
(10) Pub. No.: US 2010/0076963 A1
(43) Pub. Date: Mar. 25, 2010

(54) INDEX MAKING DEVICE, SYSTEM, PROGRAM, AND METHOD, AND RETRIEVAL DEVICE, SYSTEM, PROGRAM, AND METHOD

(75) Inventor: Naoto Kiuchi, Tokyo (JP)

Correspondence Address: YOUNG & THOMPSON, 209 Madison Street, Suite 500, Alexandria, VA, 22314, US

(73) Assignee: NEC CORPORATION, Tokyo (JP)

(21) Appl. No.: 12/526,570

(22) PCT Filed: Feb. 18, 2008
(86) PCT No.: PCT/JP2008/052657

§ 371 Date: Aug. 10, 2009

(30) Foreign Application Priority Data
Feb. 21, 2007 (JP) 2007-041507

(51) Int. Cl. G06F 17/30

(52) U.S. Cl. 707/727; 707/741; 707/E17.014; 707/E17.002

(57) ABSTRACT

Provided is an index making device for lightening a load on a network and an information-providing server. The index making device (2) comprises information acquiring means (201) for acquiring the reference information, which is acquired by a terminal device (5) demanding an information providing device (4) for sending specific information via a network (1), and the reference history information which contains the reference target information for discriminating the place where that reference information is stored, and index making means (202) for making an index for retrieving the reference information from the reference history information and the reference information, which were acquired by that information acquiring means.

### TECHNICAL FIELD

The present invention relates to retrieval of information disclosed on networks and, more specifically, to a collecting method of information provided as a retrieval result.

### BACKGROUND ART

In general, as described in Non-Patent Document 1, a retrieval server called a search engine is configured with: a crawler unit which regularly collects information disclosed on information providing servers by having a program called a crawler or a spider circulated through a public network; an index making unit which makes an index for retrieving the collected information; and a retrieval unit which receives a retrieval request from a user, searches the indexes to select the information that corresponds to the retrieval request from the user, gives some kind of ranking, and provides it as a retrieval result.

For example, with Google search (“Google” is a registered trademark) which searches HTML (Hyper Text Markup Language) texts disclosed on the Internet, information disclosed by an information provider server is collected by a crawler, indexes for retrieving the collected information are made by utilizing a method depicted in Patent Document 1, for example, and the retrieval result is provided with ranking applied thereto by utilizing PageRank or a method depicted in Patent Document 1 for the retrieval request, for example.

Patent Document 1: Japanese Unexamined Patent Publication 2006-48684

Non-Patent Document: Hayato YAMANA, Tsuyoshi MURATA, Information. Processing, Vol. 46. No. 9, pp. 981-987

A first issue is that the retrieval server of the above-described structure generates extra loads on the network and the information providing server. It is necessary for the retrieval server to collect the information to be provided in advance as the retrieval result. For that, the crawler circulates through the network to acquire the information disclosed in the information providing server. However, it is an extra load for the information providing server to be accessed for the purposes other than the primal object, which is to provide the information. Thus, it is desirable to have no such load. Further, circulation of the crawler through the network means that the retrieval server uses the network for the purposes other than reception of retrieval requests from terminals and transmission of the retrieval results to the terminals. Thus, it is also desirable to have such load.

A second issue is that the crawler for collecting the information collects the information only on a regular basis at a certain cycle. For example, if there is an incident or a disaster, various kinds of information is uploaded or existing information is updated regarding the incident or the disaster in various information providing servers. However, unless the crawler of the retrieval server acquires the information from the information providing server anew, the newly uploaded information and the updated existing information cannot be provided as the retrieval result of the retrieval server. Thus, the retrieval server cannot, provide the latest information. Furthermore, even though the information updated in the information providing server has been updated, the index in the retrieval server is made from the information that is before the update. This, it is possible that there is an inconsistency generated between the index in the retrieval server and the contents of the information uploaded on the information providing server. In that case, the retrieval server cannot provide the retrieval result that is expected by the user.

An object of the present invention is to provide an index making device and the like capable of lightening the loads imposed upon the network and the information providing server. Another object of the present invention is to provide an index making device and the like which can correspond to updates of the information disclosed on the information providing server as necessary so as to reduce the inconsistency between the index in the retrieval server and the information provided as the retrieval result.

### DISCLOSURE OF THE INVENTION

The index making device of the present invention includes: an information acquiring unit which acquires reference information acquired when a terminal device requests a transmission of specific information to an information providing device via a network and reference history information containing reference-target information for discriminating a place at which the reference information is saved; and an index making unit which makes an index for searching the reference information from the reference history information and the reference information acquired by the information acquiring unit.

The retrieval device of the present invention includes: the index making device; an index storage unit which stores an index made by the index making unit; and a retrieval unit which receives a retrieval request from the terminal device, selects information that matches the retrieval request from the index storage unit, and provides the information to the terminal device as a retrieval result.

It is also possible to overcome the foregoing issues in the same manner with an index making system, an index making program, an index making method, a retrieval system, a retrieval program, and a retrieval method.

With the present invention, it is possible to lighten the loads imposed upon the network and the information providing server. Further, it is possible to correspond to updates of the information disclosed on the information providing server as necessary so as to reduce the inconsistency between the index in the retrieval server and the information provided as the retrieval result.

### BEST MODES FOR CARRYING OUT THE INVENTION

Next, exemplary embodiments of the invention will be described in detail by referring to the accompanying drawings.

Referring to FIG. 1, a first exemplary embodiment of the invention is configured with: a public network 1; a retrieval server 2 connected to the public network 1; a proxy server 3 connected to the public network 1; an information providing server 4 connected to the public network 1; and a terminal 5 connected to the public network 1.

The retrieval server 2 is configured with an information acquiring unit 201, an index making unit 202, an index storage unit 203, and a retrieval unit 204. The retrieval server 2 acquires reference history information and reference information from the proxy server 3, and makes an index of the information that is provided as a retrieval result. At the same time, the retrieval server 2 receives a retrieval request from a user transmitted from the terminal 5, and returns the information that corresponds to the retrieval request to the terminal 5 as the retrieval result.

Note here that the reference information means information itself (e.g., HTML contents or the like) cached by an external system (e.g., the proxy server 3) when the terminal 5 refers to information disclosed in the information providing server 4. The reference history information is a record of information reference recorded by the terminal or the external system when a user directly refers to the information from the terminal 5 or refers to the information via an external system such as a proxy server or a firewall. The reference history information includes reference-maker information (e.g., IP address of a terminal) which is information that identifies who referred to the information, reference-target information (e.g., URI) which is information that identifies a site (place) of the referred information, information referred data which is the date/time at which the information was referred, and the like.

The information acquiring unit 201 acquires the reference history information and the reference information from the proxy server 3, and transmits the acquired reference history information and the reference information to the index making unit 202.

The index making unit 202 receives the reference history information and the reference information from the information acquiring unit 201, makes the indexes for searching the reference information, and records the made indexes to the index storage unit 203. While the details of an index making method is omitted since it is known to the those skilled in the art, it is possible to use TF-IDF (Term Frequency-Inverse Document Frequency) or a method depicted in Patent Document 1, for example.

The index storage unit 204 stores the indexes made by the index making unit 202.

The retrieval unit 203 receives a retrieval request from the terminal 5, searches the retrieval unit 203 and selects the information that matches the retrieval request, and transmits the information to the terminal 5 as the retrieval result by giving a proper ranking. While a ranking method of the retrieval result is omitted since it is known to those skilled in the art, it is possible to use HITS (Hyperlink-Induced Topic Search) or a method depicted in Patent Document 1, for example. Further, when there is a retrieval request from a certain terminal by using the reference-maker information and the referred date/time contained in the reference history information, the ranking of the information that has been referred by that terminal may be raised for the time zone (morning, daytime, nighttime, etc) or the time period (beginning of the month, end of the month, beginning of the fiscal year, end of the fiscal year, summer, winter, etc) which is the same time zone or the time period as that when the retrieval request is received.

The information providing server 4 receives an information transmitting request from the proxy server 3, and transmits the information designated by the proxy server 3, such as HTML contents.

The proxy server 3 relays a Web access request from the terminal 5, and makes the reference history information and the reference information while relaying it. It is also possible to use another unit and device which make the reference history information and the reference information by relaying a communication between the terminal 5 and the information providing server 4, such as a firewall instead of using the proxy server 3.

The terminal 5 is an information processor such as a personal computer used by a general user, which does not make indexes. The terminal 5 includes an information referring unit 501, and the information referring unit 501 receives a retrieval request from the user and transmits the retrieval request to the retrieval server 2. Further, the terminal 5 receives the retrieval result from the retrieval server 2, and presents it to the user. Software used exclusively or general-purpose Web browser may be used as the information referring unit 501. Further, the terminal 5 requests a transmission of information to the information providing server 4 via the proxy server 3 through specifying the necessary information by designating URL, for example. Then, the terminal 5 presents the received information to the user by displaying it on a screen, for example. Furthermore, the terminal 5 may be connected directly to the proxy server 3 via a closed-area network such as LAN (Local Area Network) without being directly connected to the public network 1, or there may be a plurality of terminals 5.

Next, operations of the first exemplary embodiment of the invention will be described by referring to flowcharts shown in FIG. 2 and FIG. 3.

The information acquiring unit 201 regularly makes inquiries to the proxy server 3 so as to check whether or not there is the reference history information and the reference information recorded after the last inquiry (S111). When there is the reference history information and the reference information recorded in the proxy server 3 after the last inquiry (judged Yes in S112), the information acquiring unit 201 acquires the reference history information and the reference information recorded after the last inquiry from the proxy server 3, and transmits it to the index making unit 202 (S113). Note that it is desirable to shorten the interval for the information acquiring unit 201 to make inquiries to the proxy server 3 as short as possible in order to increase the information provided as the retrieval result by the retrieval server 2 and in order to minimize the inconsistency between the index for the reference information and the information actually disclosed in the information providing server 4.

The index making unit 202 receives the reference history information and the reference information from the information acquiring unit 201 (S113), uses the reference information (S114), and makes the index for each piece of information for the information referred by the user written in the reference history information (S115, S121). Then, the index making unit 202 searches the index storage unit 203 to check whether or not there is the index regarding the reference information (S122).

When there is no index regarding the reference information (judged No in S122), the index making unit 202 newly registers the made index (S123). When there is a registration of the index regarding the reference information (judged Yes in S122), the index making unit 202 compares the made index with the registered index. When the contents thereof are different (judged No in S124), the index making unit 202 judges that the content of the reference information has been updated, and updates the index (S125). When the contents of the made index and the registered index are identical (judged Yes S124), the index making unit 202 judges that the content of the reference information is not being updated, so that it does not update the index.

S115 in FIG. 2, i.e., steps of S121-S125, is repeated for all pieces of information referred by the user written in all the reference history information acquired in S113 of FIG. 2 (S116), and collection of the information provided as the retrieval result and creation of the indexes for retrievals are completed.

Next, effects of the above-described first exemplary embodiment will be described.

A first effect is that it is possible to lighten the loads imposed upon the information providing server 4 and the network 1, when collecting the information required for making the index by the retrieval server and the information required for giving ranking to the retrieval result. The reason is that the retrieval server 2 collects the information provided as the retrieval result only from the information referred history of the user (reference information and the reference history information), so that the loads imposed upon the network 1 for collecting the information provided as the retrieval result is only the communication between the retrieval server 2 and the proxy sever 3. Thus, it is possible to lighten the loads imposed upon the network and the information providing server for circulating the crawler. Further, it is also because the reference-maker information and referred date/time required for giving ranking can be collected along with the reference information.

A second effect is that it is possible to minimize the inconsistency between the index for the information retrieval by the retrieval server 2 and the contents of the information actually provided by the information providing server 4. The reason is as follows. With the exemplary embodiment, the proxy server 3 records the reference information and the reference history information every time the user refers to the information disclosed in the information providing server 4 from the terminal 4 via the proxy server 3 via an external system, so that the retrieval server 2 can make the index of the re-referred information from the reference history information and the reference information recorded by the proxy server, and the index can be used for retrievals conducted thereafter. This effect becomes significant particularly for the information that is frequently updated and frequently referred.

Next, a second exemplary embodiment of the invention will be described in detail by referring to FIG. 4.

Referring to FIG. 4, the second exemplary embodiment of the invention is configured with: a public network 1, a retrieval server 2 connected to the public network 1; an information providing server 4 connected to the public network 1; and a terminal 5 connected to the public network 1. It is different from the first exemplary embodiment in respect that the second exemplary embodiment does not require a proxy server on the public network.

The retrieval server 2 is configured with an index making unit 202, an index storage unit 203, a retrieval unit 204, a relay unit 205, a relay history storage unit 206, and a relay history storage monitoring unit 207. The retrieval server 2 receives a retrieval request of a user transmitted from the terminal 5 and returns the information that matches the retrieval request to the terminal 5 as the retrieval result, while implementing a proxy function when the terminal 5 refers to the information. The index making unit 202, the index storage unit 203, and the retrieval unit 204 implement the same functions as those of the first exemplary embodiment of the invention, so that explanation thereof are not repeated herein.

The relay unit 205 implements the proxy function, which receives an acquiring request of the reference information from the terminal 5, acquires the reference information from the information providing server 4 by working as the proxy for the terminal 5, and transmits it to the terminal 5. At that time, the relay unit 205 creates the reference history information and stores it to the relay history storage unit 206 along with the reference information. Furthermore, the relay unit 205 stores the reference information to the relay history storage unit 206.

The relay history storage unit 206 stores the reference history information and the reference information created by the relay unit 205.

The relay history storage monitoring unit 207 monitors updates in the relay history storage unit 206. When new reference history information and reference information is stored in the relay history storage unit 206, the relay history storage monitoring unit 207 immediately acquires the reference history information and the reference information stored anew, and transmits it to the index making unit 202.

The terminal 5 uses the retrieval server 2 as a proxy server, when referring to the information provided by the information providing server 4.

Operations of the second exemplary embodiment of the invention will be described by referring to flowcharts of FIG. 3 and FIG. 5.

When the user uses the terminal 5 to refer to the information disclosed in the information providing server 4, the relay unit 205 stores the referred information to the relay history storage unit 206 as the reference information, while storing a record of the information reference to the relay history storage unit 206 as the reference history information.

The relay history storage monitoring unit 207 monitors updates in the relay history storage unit 206 (S201). When detecting that new reference history information and reference information are stored (judged Yes in S202), the relay history storage monitoring unit 207 immediately acquires the newly stored reference history information and reference information, and transmits it to the index making unit (S203). The index making unit 202 makes the index of the reference information according to the steps of S121-S125 (S204: S121-S125), and stores it to the index storage unit 203.

In the second exemplary embodiment of the invention, the retrieval server 2 also has the function of the proxy server, so that the information provided as the retrieval result is Collected only within the retrieval server 2. Therefore, it is possible to achieve an effect of further lightening the loads imposed upon the network 1 for collecting the information. Further, the index of the referred information is updated immediately after the user refers to the information, so that it is possible to achieve an effect of minimizing the inconsistency between the index and the contents.

Next, a third exemplary embodiment of the invention will be described in detail by referring to the drawings.

Referring to FIG. 6, the third exemplary embodiment of the invention is configured with: a public network 1; a retrieval server 2 connected to the public network 1; an information providing server 4 connected to the public network 1; and a terminal 5 connected to the public network 1.

It is different from the first and second exemplary embodiments in respect that the retrieval server 2 is configured with an index making unit 202, an index storage unit 203, a retrieval unit 204, a reference history receiving unit 208, a reference history storage unit 209, and a reference history storage monitoring unit 210, and that the retrieval server 2 receives a retrieval request of a user transmitted from the terminal 5 and returns the information that matches the retrieval request to the terminal 5 as the retrieval result, and receives the reference history information and the reference information from the terminal 5.

The index making unit 202, the index storage unit 203, and the retrieval unit 204 implement the same functions as those of the first exemplary embodiment of the invention, so that explanation thereof are not repeated herein.

The reference history receiving unit 208 receives the reference history information and the reference information from a reference history information transmitting unit 503 of the terminal 5 described later, and stores it to the reference history storage unit 209 described later. Note here that the reference history information contains user discriminating information that is the information for uniquely discriminating the user who is referring to the information via the terminal 5. For the user discriminating information, the log-in ID or the like used when the user logs in to the terminal 5 may be used.

The reference history storage unit 209 stores the reference history information and the reference information received from the terminal 5.

The reference history storage monitoring unit 210 monitors updates in the reference history storage unit 209. When new reference history information and reference information is stored in the reference history storage unit 209, the reference history storage monitoring unit 210 immediately acquires the reference history information and the reference information stored anew, and transmits it to the index making unit 202.

The terminal 5 is different from those of the first and second exemplary embodiments in respect that it has a reference history storage unit 502 and the reference history transmitting unit 503, in addition to an information referring unit 501. In addition to having the function of the first exemplary embodiment of the invention, the information referring unit 501 stores the reference history information and the reference information to the reference history storage unit 502 while referring to the information.

The reference history storage unit 502 stores the reference history information and the reference information.

The reference history transmitting unit 503 regularly transmits the reference information, the reference history information, and the user discriminating information stored in the reference history storage unit 502 to the reference history receiving unit 208.

Operations of the third exemplary embodiment of the invention will be described by referring to flowcharts of FIG. 7, FIG. 8, and FIG. 3.

When the user uses the information referring unit 501 to refer to the information disclosed in the information providing server 4, the information referred by the information referring unit 501 is recorded to the reference history storage unit 502 as the reference information, and a record of the information reference is recorded to the reference history storage unit 502 as the reference history information (S311). The reference history transmitting unit 503 makes an inquiry to the reference history storage unit 502 regularly (S312), and checks whether or not there is the reference history information and the reference information recorded after the last inquiry (S131). When there is the reference history information and the reference information recorded in the reference history storage unit 502 after the last inquiry (judged Yes in S313), the reference history transmitting unit 503 acquires the reference history information and the reference information recorded after the last inquiry from the reference history storage unit 502 and transmits it to the reference history receiving unit 208 along with the information for discriminating the user of the terminal 5 (S314). The steps of S311-S314 are repeated until completing the information referred by the user via the information referring unit 501 (S315).

In order to increase the information provided as the retrieval result by the retrieval server 2 and in order to minimize the inconsistency between the index for the reference information of the retrieval server 2 and the information actually disclosed in the information providing server 4, it is desirable to have the reference history transmitting unit 503 monitor the updates in the reference history storage unit 502 and, when detecting that new reference history information and reference information is stored to the reference history storage unit 502, have the reference history transmitting device 503 acquire the newly stored reference history information and the reference information immediately to transmit it to the reference history receiving unit 208.

Then, upon receiving the reference history information and the reference information from the reference history transmitting unit 503, the reference history receiving unit 208 stores the received reference history information and reference information to the reference history storage unit 209.

The reference history storage monitoring unit 210 monitors updates of the reference history storage unit 209 (S321). When detecting that new reference history information and reference information is stored in the reference history storage unit 209 (judged Yes in S322), the reference history storage monitoring unit 210 immediately acquires the newly stored reference history information and reference information from the reference history storage unit 209, and transmits it to the index making unit 202 (S323).

The index making unit 202 makes the index of the reference information for each user according to the steps of S121-S125 in FIG. 3 (S324), and stores the indexes to the index storage unit 203 (S324).

The retrieval unit 204 retrieves the index and gives ranking to the retrieval result as in the case of the first exemplary embodiment, when there is a retrieval request from the terminal 5. However, the terminal 5 herein transmits the retrieval request including the user discriminating information, and the retrieval unit 204 gives ranking by considering the reference history of the user having the user discriminating information that is contained in the retrieval request. For example, the number of references made by the user to each piece of reference information is counted, and the ranking of the information having the same index as that of the reference information that is most frequently referred by the user may be raised.

In the third exemplary embodiment of the invention, the reference history information contains the user discriminating information, so that it is possible to collect the reference history information and the reference information not by each terminal but by each user. Therefore, in addition to the effect of the first exemplary embodiment of the invention, the third exemplary embodiment can have an effect of taking the preference of each user into consideration when providing the retrieval result.

Next, a fourth exemplary embodiment of the invention will be described in detail by referring to the drawings.

Referring to FIG. 9, the fourth exemplary embodiment of the invention is configured with: a public network 1; a retrieval server 2 connected to the public network 1; a proxy server 3 connected to the public network 1; an information providing server 4 connected to the public network 1; an information collecting server 6 connected to the public network 1; and a terminal 5 connected to the public network 1. It is different from the first exemplary embodiment in respect that the fourth exemplary embodiment collects the information provided as the retrieval result from the proxy server 3 and the information collecting server 6.

The retrieval server 2 is configured with an information acquiring unit 201, an index making unit 202, an index storage unit 203, and a retrieval unit 204. In addition to the operations of the first exemplary embodiment of the invention, the retrieval server 2 of the fourth exemplary embodiment is different from that of the first exemplary embodiment in respect that it acquires the reference history information and the reference information also from the information collecting server 6, and makes the index of the information that is provided as the retrieval result. Further, it is also different from that of the first exemplary embodiment in respect that this retrieval server 2 transmits the reference-target information contained in the reference history information acquired from the proxy server 3 to the information collecting server 6.

The information acquiring unit 201 acquires the reference history information and the reference information from the proxy server 3, and transmits the acquired reference history information and the reference information to the index making unit 202, as in the case of the first exemplary embodiment of the invention. Further, this information acquiring unit 201 is different from that of the first exemplary embodiment in respect that it acquires a set of the reference-target information, the reference information, and the information referred date/time from a collected information storage unit 603 described later, and transmits the acquired reference-target information and the referred date-time as the reference history information to the index making unit 202 along with the reference information acquired from the collected information storage unit 603. In addition, this information acquiring unit 201 is different from that of the first exemplary embodiment of the invention in respect that it transmits the reference-target information contained in the reference history information acquired from the proxy server 3 to an information collecting unit 602 described later.

The index making unit 202 receives the reference history information and the reference information from the information acquiring unit 201, makes the indexes for retrieving the reference information, and stores a set of the made index and the date/time at which the index was made to the index recording unit 203.

The index storage unit 203 stores the set of the index made by the index making unit 202 and the date/time at which the index was made.

The information collecting server 6 is configured with an information collected address list storage unit 601, the information collecting unit 602, and the collected information storage unit 603, and it has a similar function as that of a crawler unit of a conventional retrieval server. The information collecting server 6 may be mounted as a part of the retrieval server 2.

The information collected address list storage unit 601 stores a list of the reference-target information as the retrieval-target information to be collected for being provided as the retrieval result.

The information collecting unit 602 acquires the retrieval-target information stored in the information collected address list storage unit 601, and acquires the reference information written in the retrieval-target information from the information providing server 4. Further, the information collecting unit 602 stores a combination of the reference-target information and the referred date/time to the collected information storage unit 603 as the reference history information along with the date/time at which the reference information and the reference information was acquired from the information providing server. In addition, the information collecting unit 602 cancels the reference-maker information transmitted from the information acquiring unit 201 from the retrieval-target information that is stored in the information collected address list storage unit 601 to be excluded from the target information to be collected.

The collected information storage unit 603 stores the reference history information and the reference information.

In order to lighten the loads for the network because of the communications between the retrieval server 2 and the information collecting server 6, the information collecting server 6 may be mounted by being included in the retrieval server 2.

Operations of the fourth exemplary embodiment of the invention will be described by referring to flowcharts of FIG. 10, FIG. 11, FIG. 2, and FIG. 3.

The information collecting unit 602 acquires the retrieval-target information from the information collected address list storage unit 601 (S411). Further, the information collecting unit 602 acquires, from the information providing server 4, the reference information one by one, which is designated in the reference-target information depicted in the retrieval-target information acquired in S411, and stores the information to the collected information storage unit 603 along with the referred date/time (S412). After acquiring the reference information for all the reference-target information depicted in the retrieval-target information acquired in S411 (judged Yes in S412), the steps of S411-S413 are repeated until completing the information collecting server 6 (until it is judged Yes in S414).

Further, the information collecting unit 602 receives the reference-target information from the information acquiring unit 201 in parallel to the steps of S411-S414 (S421), and checks, one by one, whether or not the reference-target information received in S421 is stored in the retrieval-target information that is stored in the information collected address list storage unit 601 (S422). If stored, the information collecting unit 602 cancels the reference-target information received from the information collected address list storage unit 601 in S421 (S423) to exclude it from the target information to be collected. The steps of S422-S423 are executed on all the reference-target information received in S421 to perform sort-out processing of the retrieval-target information.

The information acquiring unit 201 regularly makes inquiries to the proxy server 3 and the collected information storage unit 603 so as to check whether or not there is the reference history information and the reference information recorded after the last inquiry (S111). When there is the reference history information and the reference information recorded in the proxy server 3 and the collected information storage unit 603 after the last inquiry (judged Yes in S112), the information acquiring unit 201 acquires the reference history information and the reference information recorded after the last inquiry from the proxy server 3 and the collected information storage unit 603, and transmits it to the index making unit 202 (S112).

The index making unit 202 makes the indexes according to the flowchart of FIG. 3.

As in the above-described exemplary embodiments, it is also possible to employ the information collecting server 6 to the second or the third exemplary embodiment.

In the fourth exemplary embodiment of the invention, the information provided as the retrieval result is collected from the reference history information generated by the proxy server 3 and from the information collecting server 6. Thus, it is possible to have an effect of providing information that has never been referred by any users of the retrieval server 2 as the retrieval result. Further, the reference-maker information written in the reference history information generated by the proxy server 3 is excluded from the target information to be collected by the information collecting server 6, so that the targets of information to be collected can be limited for the information collecting server 6. Therefore, it has an effect of lightening the loads imposed upon the network 1 and the information providing server 4 compared to the case of a conventional retrieval server.

### Example 1

Next, EXAMPLE of the present invention will be described by referring to the drawings. It is assumed herein that following five events from 1) to 7) took place in a following order.

1) A user A uses a terminal “a” designated by an IP address XX.XX.XX.XX to refer to an HTML content X including keywords “search engine” and “optimization”, which is disclosed at URL “http://infoserver.net/search.html” on the information providing server 4 that exits on the Internet.

2) The retrieval server 2 makes an inquiry to the proxy server 3 to check whether or not there is new reference history information and reference information.

3) A user B uses a terminal “b” designated by an IP address YY.YY.YY.YY and the retrieval server 2 to retrieve the content containing a keyword “search engine” among the HTML contents that are disclosed on the Internet.

4) The HTML content X is updated to an HTML content X′ which is disclosed at URL “http://inforserver.net/search.html”, and contains keywords “redundancy” and “high-speed” but does not contain “search engine”.

5) A user C uses a terminal “c” designated by an IP address ZZ.ZZ.ZZ.ZZ to refer to the HTML content X′ which is disclosed at URL “http://infoserver.net/search.html” on the information providing server 4 that exits on the Internet.

6) The retrieval server 2 makes an inquiry again to the proxy server 3 to check whether or not there is new reference history information and reference information.

7) A user D uses a terminal “d” designated by an IP address WW.WW.WW.WW and the retrieval server 2 to retrieve the content containing a keyword “search engine” among the HTML contents that are disclosed on the Internet.

Next, described is EXAMPLE in which the procedure from 1) to 7) described above is executed with the first exemplary embodiment.

When a user A refers to the HTML content X from the terminal “a” via the proxy server 3, the proxy server 3 stores the reference history information indicating that the terminal designated by the IP address XX.XX.XX.XX has referred to the content X and, further, caches the content X. FIG. 12 shows an example of reference history information.

Then, the information acquiring unit 201 of the retrieval server 2 makes an inquiry to the proxy server 3 so as to check whether or not there is the reference history information and the reference information recorded after the last inquiry (S211). At this time, the content X′ is stored in the proxy server 3 as a single piece of the reference history information and the reference information shown in FIG. 12 (judged Yes in S112). The information acquiring unit 201 of the retrieval server 2 acquires the reference history information and the content X shown in FIG. 12 from the proxy server 3 (S113), and transmits the acquired reference history information and the content X shown in FIG. 12 to the index making unit 202. Since there is only one piece of reference history information that is transmitted regarding the content X, the index making unit 202 makes the index of the content X that is disclosed at URL http://infoserver.net/search.html from the reference history information and the content X shown in FIG. 12, which are transmitted from the information acquiring unit 201 (S114, S121). FIG. 13 shows examples of the indexes of the content X. Further, FIG. 14 shows examples of the indexes stored in the index storage unit 203.

The index of the content X is not in the indexes shown in FIG. 14 (judged No in S122). Thus, the index making unit 202 records the index of the content X to the index storage unit 203 (S123), and the index processing is completed.

Then, when the user B executes the search of 3), a retrieval request indicating an HTML content containing a keyword “search engine” is transmitted from the terminal “b” to the retrieval unit 204 of the retrieval server 2. Upon receiving the retrieval request, the retrieval unit 204 selects all the contents that have “search engine” as the index from the index storage unit 203, and transmits those to the terminal “b” as the retrieval result. At this time, the content X contained in the retrieval result.

Then, when the user C refers to the HTML content X′ from the terminal “c”, the proxy server 3 stores the reference history information shown in FIG. 15 which indicates that the terminal designated by the IP address ZZ.ZZ.ZZ.ZZ has referred to the content X′, and stores the content X′ as a cache.

Again, the information acquiring unit 201 of the retrieval server 2 makes an inquiry to the proxy server 3 so as to check whether or not there is the reference history information and the reference information recorded after the last inquiry (S111). At this time, the content X′ is stored in the proxy server 3 as a single piece of the reference history information and the reference information shown in FIG. 15 (judged Yes in S112). The information acquiring unit 1 of the retrieval server 2 acquires the reference history information and the content X′ shown in FIG. 15 from the proxy server 3 (S113), and transmits the acquired reference history information and the content X′ shown in FIG. 15 to the index making unit 202. Since there is only one piece of reference history information that is transmitted regarding the content X′, the index making unit 202 makes the index of the content X′ that is disclosed at URL http://infoserver.net/search.html from the reference history information and the content X′ shown in FIG. 16, which are received from the information acquiring unit 201 (S121). FIG. 16 shows examples of the indexes of the content X′. The indexes stored in the index storage unit 203 contain the indexes of the contents that have already been disclosed at URL http://infoserver.net/search.html (judged Yes in S122). However, those are different from the indexes of FIG. 16, which are made anew (judged No in S124). Thus, the index making unit 202 updates the indexes of the contents disclosed at URL http://infoserver.net/search.html (S125). FIG. 17 shows the updated indexes.

Further, when the user D executes the search of 7), a retrieval request indicating an HTML content containing keyword “search engine” is transmitted from the terminal “d” to the retrieval unit 204 of the retrieval server 2. Upon receiving the retrieval request, the retrieval unit 204 selects all the contents that have “search engine” as the index from the index storage unit 203, and transmits those to the terminal “d” as the retrieval result. At this time, the content X′ is not contained in the retrieval result, and the latest contents disclosed at URL http://infoserver.net/search.html are reflected thereupon.

While the present invention has been described by referring to the embodiments (and examples), the present invention is not limited only to those embodiments (and examples) described above. Various kinds of modifications that occur to those skilled in the art can be applied to the structures and details of the present invention within the scope of the present invention.

This Application claims the Priority right based on Japanese Patent Application No. 2007-041507 filed on Feb. 21, 2007, and the disclosure thereof is hereby incorporated by reference in its entirety.

### BRIEF DESCRIPTION OF THE DRAWINGS

FIG. 1 is a block diagram showing a structure of a first exemplary embodiment of the invention:

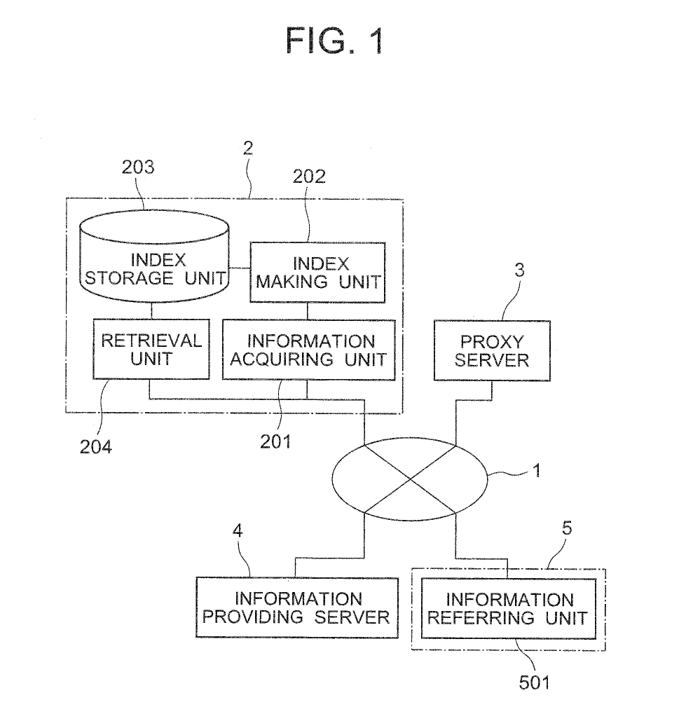

FIG. 2 is a flowchart for describing operations of the first exemplary embodiment of the invention;

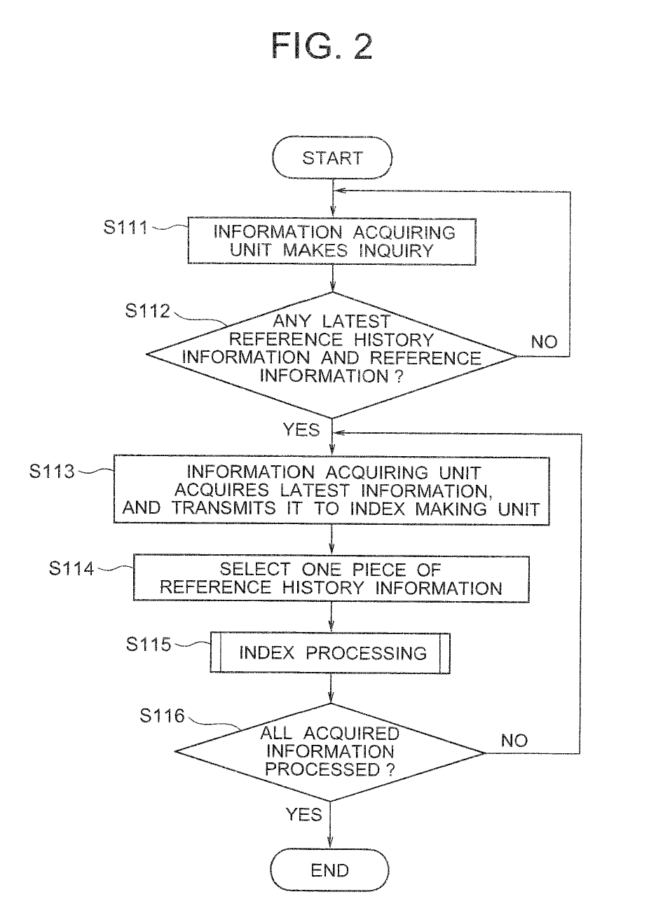

FIG. 3 is a flowchart for describing index making processing executed in a retrieval server among the operation of the exemplary embodiment of the invention;

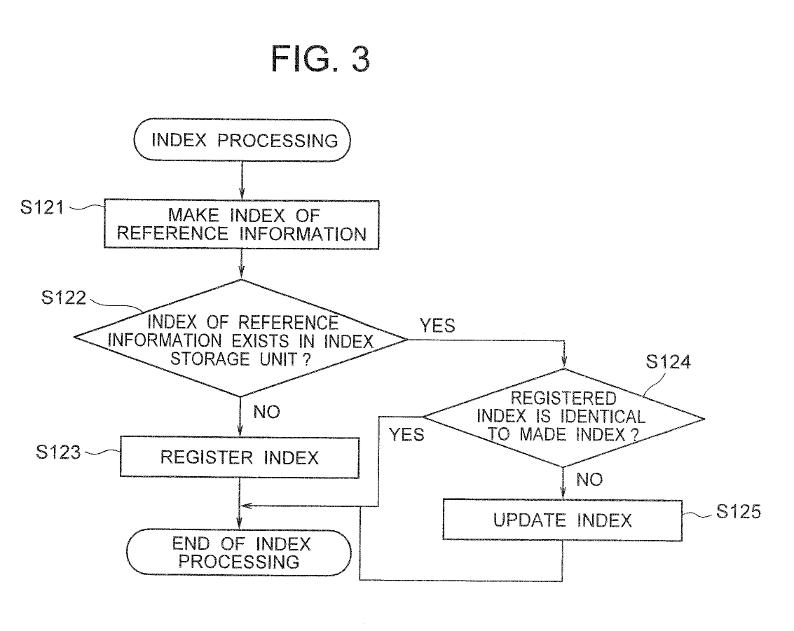

FIG. 4 is a block diagram showing a structure of a second exemplary embodiment of the invention:

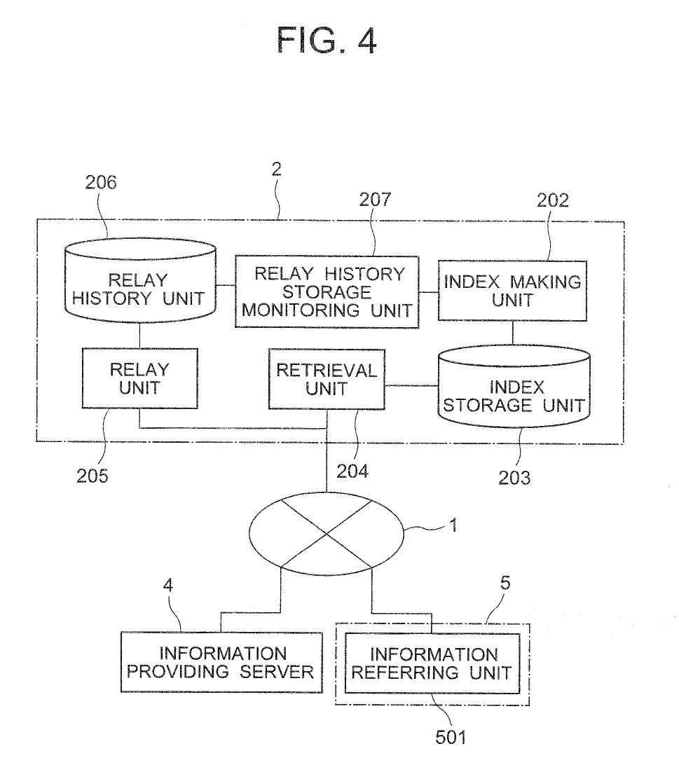

FIG. 5 is a flowchart for describing operations of the second exemplary embodiment of the invention;

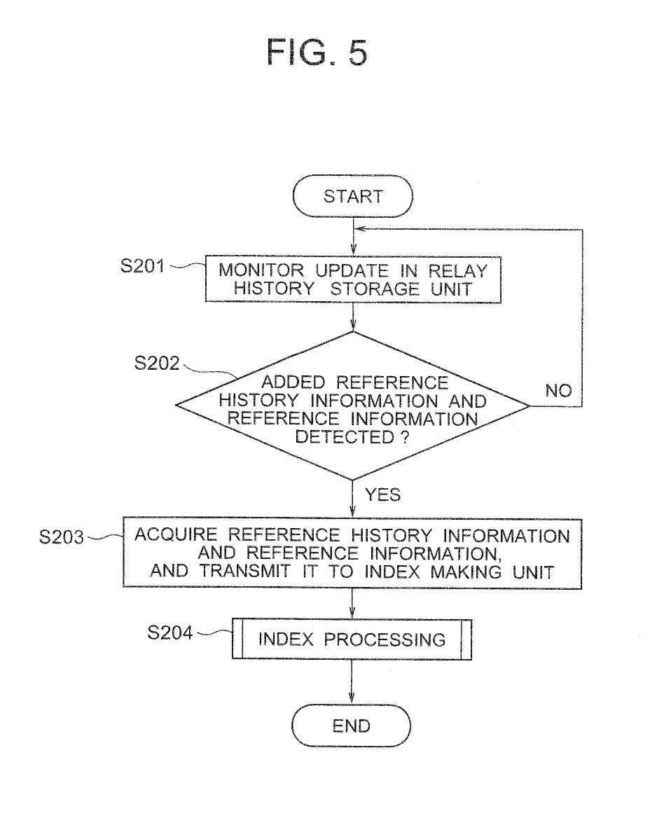

FIG. 6 is a block diagram showing a structure of a third exemplary embodiment of the invention:

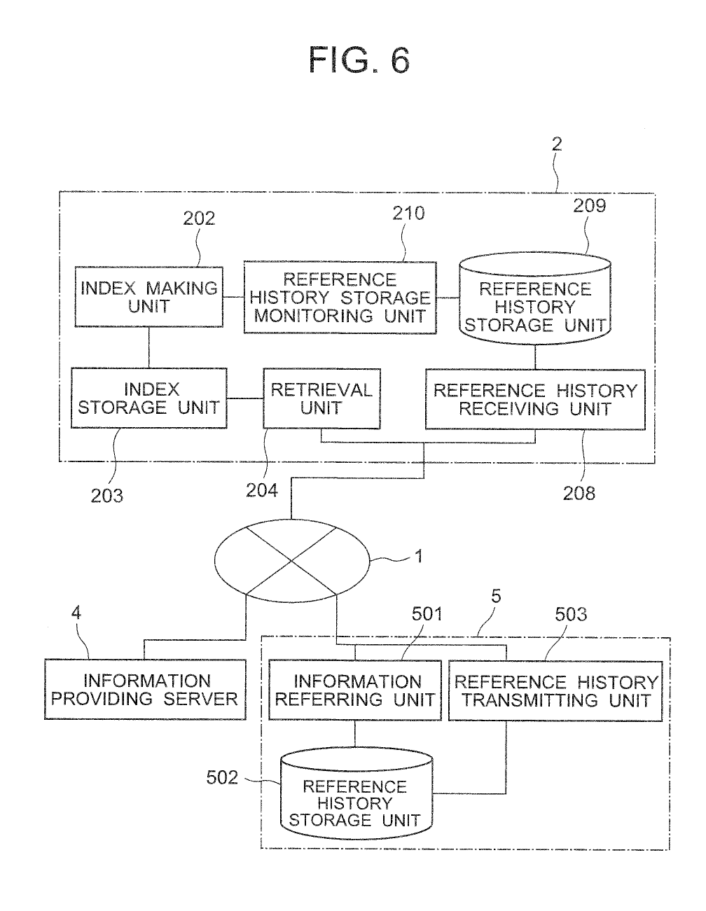

FIG. 7 is a flowchart for describing operations of a terminal according to the third exemplary embodiment of the invention;

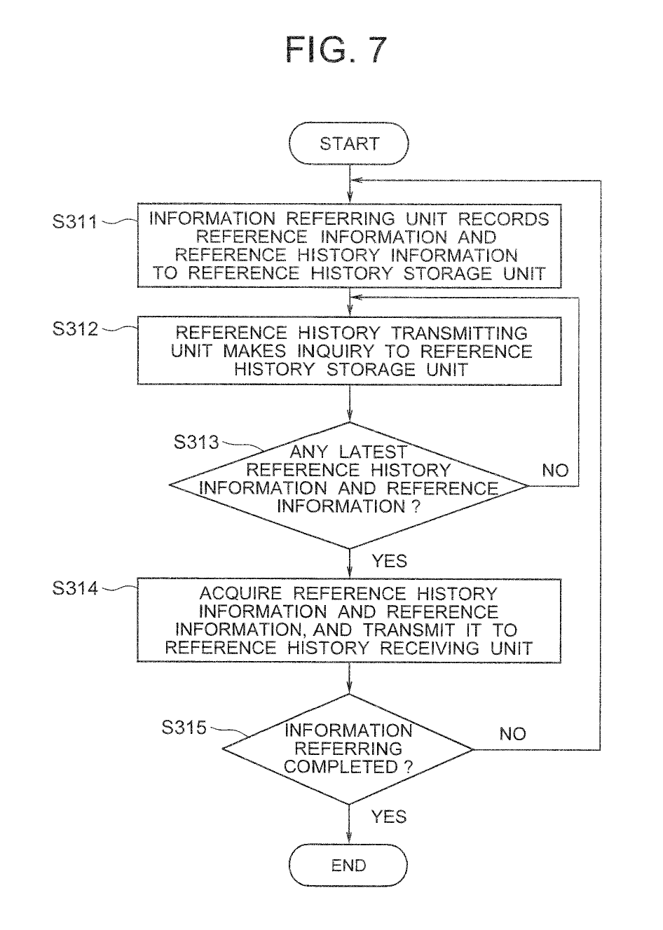

FIG. 8 is a flowchart for describing operations of a retrieval server according to the third embodiment of the present invention;

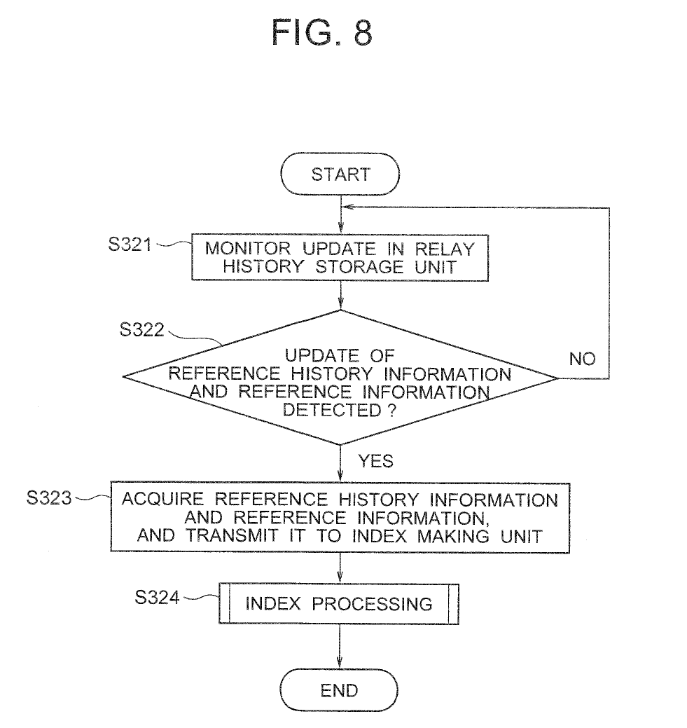

FIG. 9 is a block diagram showing a structure of a fourth exemplary embodiment of the invention:

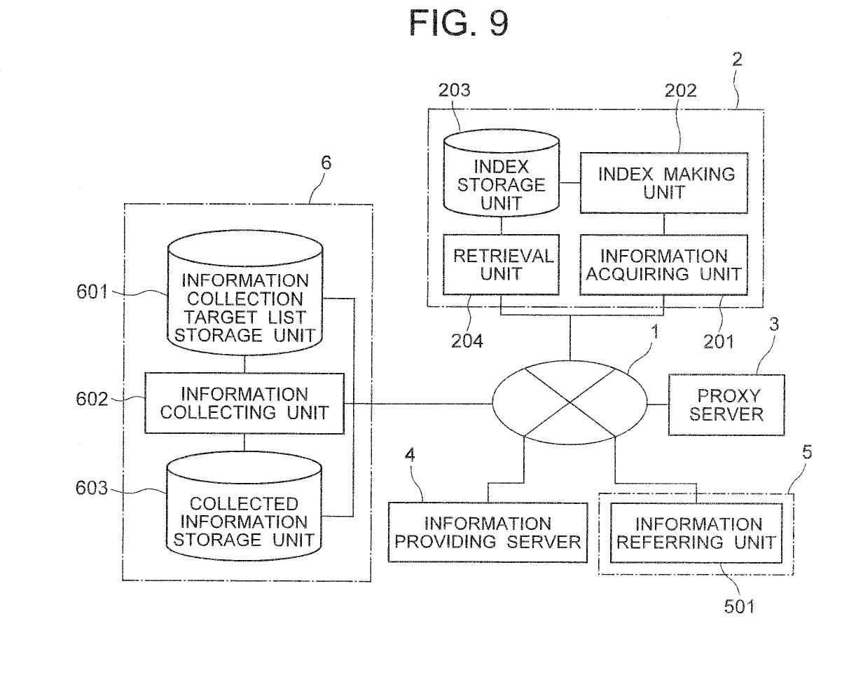

FIG. 10 is a flowchart showing an information collecting operation executed by an information collecting server 6 according to the fourth exemplary embodiment of the invention;

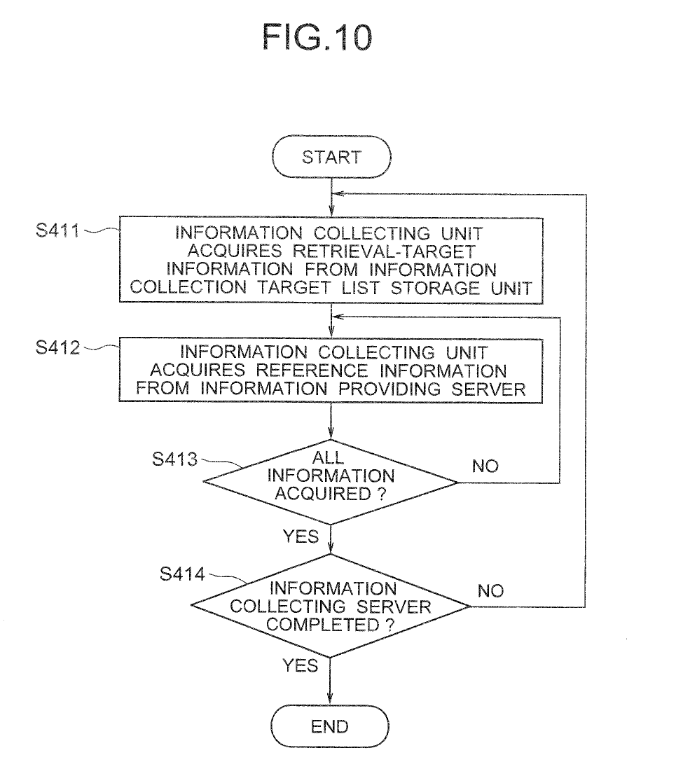

FIG. 11 is a flowchart showing a retrieval-target information sort-out operation executed by the information collecting server 6 according to the fourth exemplary embodiment of the invention;

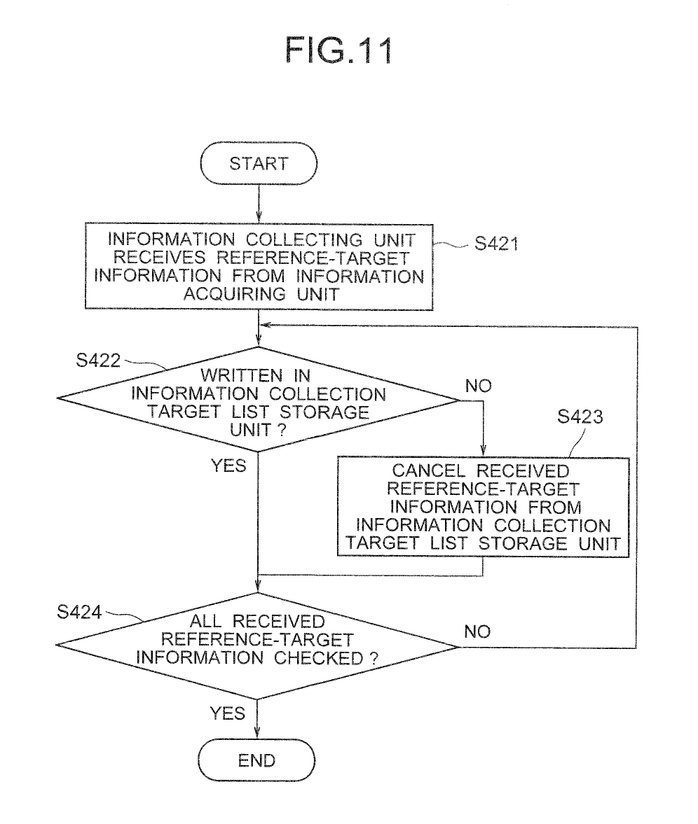

FIG. 12 is an example of reference history information of a content X according to the present invention;

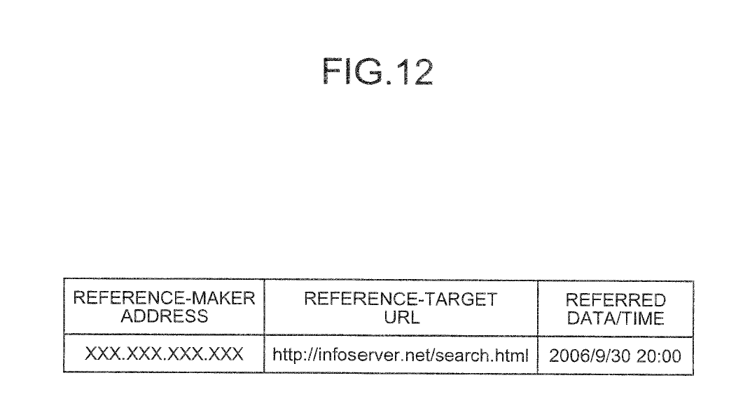

FIG. 13 shows examples of indexes of the content X according to the present invention;

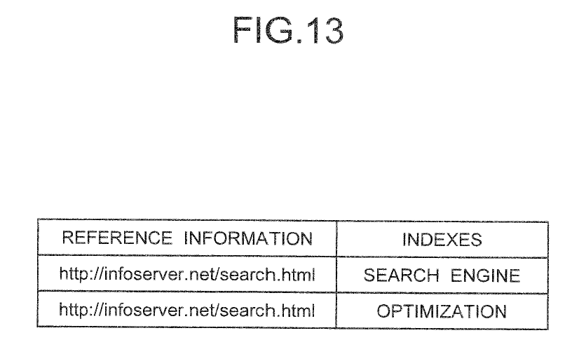

FIG. 14 shows examples of indexes stored in an index storage unit of the present invention;

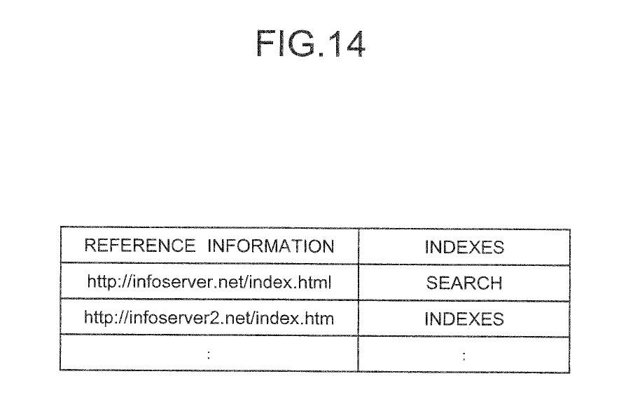

FIG. 15 is an example of reference history information of a content X′ according to the present invention;

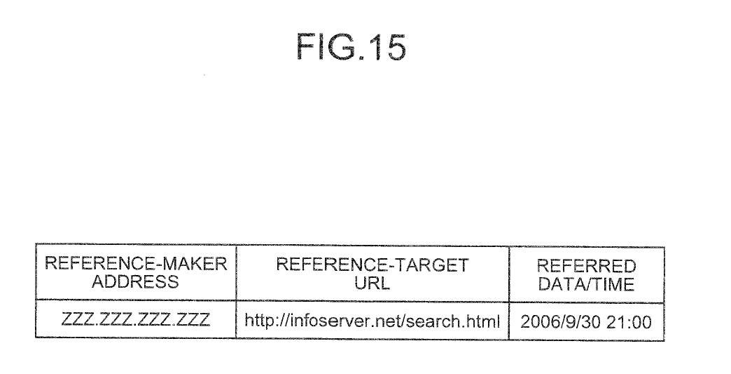

FIG. 16 shows examples of indexes of the content X′ according to the present invention; and

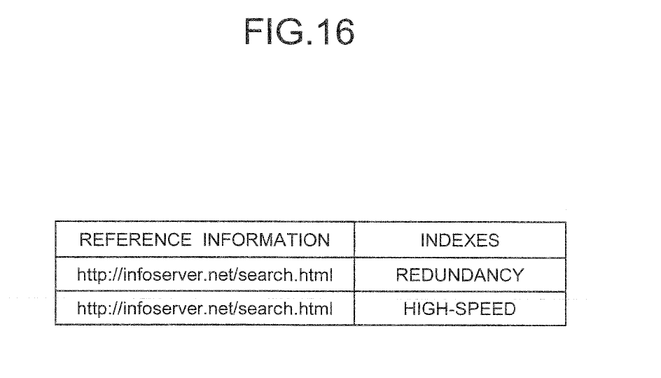

FIG. 17 shows examples of updated indexes that are stored in the index storage unit of the present invention.

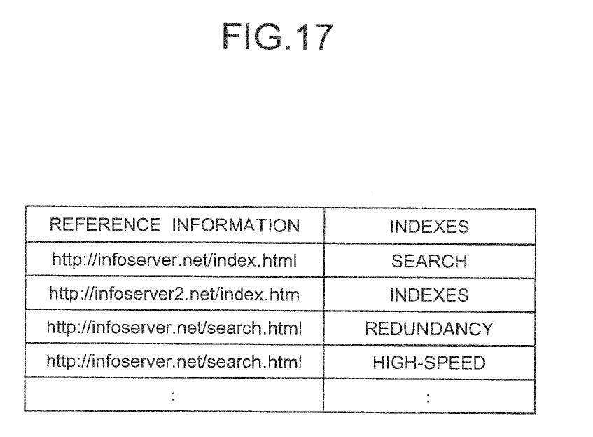

### REFERENCE NUMERALS

1 Public network
2 Retrieval server
201 Information acquiring unit
202 Index making unit
203 Index storage unit
204 Retrieval unit
205 Relay unit
206 Relay history storage unit
207 Relay history storage monitoring unit
208 Reference history receiving unit
209 Reference history storage unit
210 Reference history storage monitoring unit
3 Proxy server
4 Information providing server
5 Terminal
501 Information referring unit
502 Reference history storage unit
503 Reference history transmitting unit
6 Information collecting server
601 Information collection target list storage unit
602 Information collecting unit
603 Collected information storage unit

1-36. (canceled)

37. An index making device, comprising:
an information acquiring unit which acquires, from a terminal device, reference information that is acquired and stored by the terminal device by requesting a transmission of specific information to an information providing device via a network and acquires reference history information containing reference-target information for discriminating a place at which the reference information is saved and information for discriminating a user; and
an index making unit which makes an index for searching the reference information from the reference history information and the reference information acquired by the information acquiring unit.

38. A retrieval device, comprising:
the index making device as claimed in claim 37;
an index storage unit which stores an index made by the index making unit; and
a retrieval unit which receives a retrieval request from the terminal device, selects information that matches the retrieval request from the index storage unit, and provides the information to the terminal device as a retrieval result.

39. The retrieval device as claimed in claim 38, wherein:
the reference history information includes information referred data/time which shows data/time at which the terminal device referred to the reference information; and
the retrieval unit gives ranking to the retrieval result based on the reference history information.

40. The retrieval device as claimed in claim 38, wherein the retrieval unit receives the user discriminating information along with the retrieval request, and gives the ranking by considering the reference history of the user that has the received user discriminating information.

41. An index making system, comprising a terminal device which requests a transmission of specific information to an information providing device via a network, and an index making device which makes an index for retrieving information disclosed by the information providing device, wherein
the index making device comprises:
an information acquiring unit which acquires, from the terminal device, reference information that is acquired and stored by the terminal device by requesting a transmission of specific information to the information providing device via the network and acquires reference history information containing reference-target information for discriminating a place at which the reference information is saved and information for discriminating a user; and
an index making unit which makes an index for searching the reference information from the reference history information and the reference information acquired by the information acquiring unit.

42. A retrieval system, comprising a retrieval server which comprises:
the index making device as claimed in claim 41;
an index storage unit which stores an index made by the index making unit; and
a retrieval unit which receives a retrieval request from the terminal device, selects information that matches the retrieval request from the index storage unit, and provides the information to the terminal device as a retrieval result.

43. The retrieval system as claimed in claim 42, wherein:
the reference history information includes information referred data/time which shows data/time at which the terminal device referred to the reference information; and
the retrieval unit gives ranking to the retrieval result based on the reference history information.

44. The retrieval system as claimed in claim 42, wherein the retrieval unit receives the user discriminating information along with the retrieval request, and gives the ranking by considering the reference history of the user that has the received user discriminating information.

45. A computer readable recording medium storing an index making program for enabling a computer to function as:
an information acquiring unit which acquires, from a terminal device, reference information that is acquired and stored by the terminal device by requesting a transmission of specific information to an information providing device via a network and acquires reference history information containing reference-target information for discriminating a place at which the reference information is saved and information for discriminating a user; and
an index making unit which makes an index for searching the reference information from the reference history information and the reference information acquired by the information acquiring unit.

46. A computer readable recording medium storing a retrieval program for enabling a computer to function as:
the index making device as claimed in claim 45;
an index storage unit which stores an index made by the index making unit; and
a retrieval unit which receives a retrieval request from the terminal device, selects information that matches the retrieval request from the index storage unit, and provides the information to the terminal device as a retrieval result.

47. The computer readable recording medium storing the retrieval program as claimed in claim 46, wherein the reference history information includes information referred data/time which shows data/time at which the terminal device referred to the reference information, the program enabling the computer to work as the retrieval unit to execute a function of giving ranking to the retrieval result based on the reference history information.

48. The computer readable recording medium storing the retrieval program as claimed in claim 46, which enables the computer to work as the retrieval unit to receive the user discriminating information along with the retrieval request, and give the ranking by considering the reference history of the user that has the received user discriminating information.

49. An index making method, comprising:
an information acquiring step in which an index making device acquires, from a terminal device, reference information that is acquired and stored by the terminal device by requesting a transmission of specific information to an information providing device via a network and acquires reference history information containing reference-target information for discriminating a place at which the reference information is saved and information for discriminating a user; and
an index making step in which the index making device makes an index for searching the reference information from the reference history information and the reference information acquired by the information acquiring unit.

50. A retrieval method which makes an index by the index making method as claimed in claim 49, comprising:
a retrieval step in which the index making device stores an index made in the index making step to an index storage unit, receives a retrieval request from the terminal device, selects information that matches a retrieval request from the index storage unit, and provides the information to the terminal device as a retrieval result.

51. The retrieval method as claimed in claim 50, wherein:
the reference history information includes information referred data/time which shows data/time at which the terminal device referred to the reference information; and
the retrieval step gives ranking to the retrieval result based on the reference history information.

52. The retrieval method as claimed in claim 50, wherein the retrieval step receives the user discriminating information along with the retrieval request, and gives the ranking by considering the reference history of the user that has the received user discriminating information.

53. An index making device, comprising:
information acquiring means for acquiring, from a terminal device, reference information that is acquired and stored by the terminal device by requesting a transmission of specific information to an information providing device via a network and acquires reference history information containing reference-target information for discriminating a place at which the reference information is saved and information for discriminating a user; and
index making means for making an index for searching the reference information from the reference history information and the reference information acquired by the information acquiring means.

54. An index making system, comprising terminal means for requesting a transmission of specific information to an information providing device via a network, and index making means for making an index for retrieving information disclosed by the information providing device, wherein
the index making means comprises:
information acquiring means for acquiring, from the terminal means, reference information that is acquired and stored by the terminal means by requesting a transmission of specific information to the information providing device via the network and acquires reference history information containing reference-target information for discriminating a place at which the reference information is saved and information for discriminating a user; and
index making means for making an index for searching the reference information from the reference history information and the reference information acquired by the information acquiring means.
